(19) United States
(12) Patent Application Publication
(10) Pub. No.: US 2023/0419172 A1
(43) Pub. Date: Dec. 28, 2023

(54) MANAGING TRAINING OF A MACHINE LEARNING MODEL

(71) Applicant: Telefonaktiebolaget LM Ericsson (publ), Stockholm (SE)

(72) Inventors: Selim Ickin, Stockholm (SE); Hassam Riaz, Järfälla (SE); Hannes Larsson, Solna (SE)

(21) Appl. No.: 18/035,333

(22) PCT Filed: Nov. 5, 2020
(86) PCT No.: PCT/IB2020/060416

§ 371 Date: May 4, 2023

(51) Int. Cl. G06N 20/00

(52) U.S. Cl. CPC G06N 20/00

(57) ABSTRACT

There is provided a method performed by a master node for managing training of a machine learning model. One or more worker nodes of a plurality of worker nodes are selected to train a machine learning model in a round of training. The one or more worker nodes are selected to optimize a performance of an updated machine learning model for a validation dataset after the round of training. The updated machine learning model has one or more parameters of the machine learning model trained by the one or more worker nodes in a previous round of training.

### TECHNICAL FIELD

The disclosure relates to a method for managing training of a machine learning model and a node configured to operate in accordance with that method.

### BACKGROUND

In the field of machine learning, various techniques exist for training a machine learning model. One of these techniques is federated machine learning, which is a distributed machine learning technique. In this technique, a machine learning model is trained by each of a plurality of worker nodes on a dataset that is local to them. The plurality of worker nodes that contribute to training the machine learning model is referred to in the art as a federation.

Since the parameters of a machine a machine learning model trained by the plurality of worker nodes 20, 30, 40 are averaged in federated machine learning, the objective function of the machine learning process needs to have a common place to which it can converge. Otherwise, the machine learning model may be better off without a specific worker node in the federation. Thus, in a multi-operator federated learning setting, it can be beneficial to group worker nodes having local datasets with similar characteristics into the same federation. For example, techniques for measuring similarities in datasets (e.g. using statistical tests, clustering, cosine similarity, Euclidean distance, or Gaussian mixture models) may be run on the local datasets of the individual worker nodes in order to identify local datasets with similar characteristics. The worker nodes having local datasets with similar characteristics can then be grouped together to form a federation, with other worker nodes excluded from the federation, such that only worker nodes of the federation contribute to training the machine learning model. The techniques for measuring similarities in datasets are generally executed once, before training begins.

The idea behind grouping worker nodes having local datasets with similar characteristics into a federation is to prevent the worker nodes of the federation from receiving parameters of a machine learning model trained by an irrelevant worker node outside of the federation. Due to the difference in the local dataset of a worker node outside the federation compared to the worker nodes inside the federation, the worker node outside the federation is unlikely to be able to contribute in a positive way to the performance of the federation. In particular, the parameters of a machine learning model trained by a worker node outside of the federation are unlikely to benefit the worker nodes of the federation and can potentially reduce the accuracy of the worker nodes of the federation.

The grouping of worker nodes into a federation can also be useful in preventing malicious worker nodes from poisoning other worker nodes, since malicious worker nodes can be excluded from a federation. The poisoning of parameters of machine learning models is an open issue in federated machine learning and there are various techniques aimed at detecting such parameter poisoning, such as detecting poisoning attacks based on the parameter updates received from the worker nodes. An example of such a technique uses cosine similarity to quantify and detect the similarity in between parameter updates. However, while the techniques for detecting parameter poisoning can be useful, it is better to prevent the poisoning from happening in the first place, which is why the grouping of worker nodes into a federation that excludes malicious worker nodes has proven to be valuable.

Even so, while the grouping of worker nodes into a federation according to the above-described techniques can offer some advantages, the techniques are also far from ideal. In particular, looking at the similarities of local datasets may not actually be enough to determine whether those local datasets are a good fit for federated machine learning. For instance, there could be a scenario, where worker A and worker B potentially have similar local datasets if their local datasets were of a similar size, whereas in reality worker A may have a diverse and balanced local dataset and worker B may have a very limited local dataset, which only contains a small subset of the full feature space for the task. In such a case, worker A may naturally be beneficial for worker B, but worker B may not improve to the performance for worker A. Thus, grouping worker nodes based on similarities in local datasets may not be optimal.

Also, in addition to the risk of sub-optimal groupings, the grouping of worker nodes based on similarities in local datasets of different worker nodes is in violation of the privacy of the different operators. Moreover, the grouping techniques also require extensive pre-processing and manual work, which mean that they are inefficient and error prone.

At the same time, clustering and debugging local datasets by actually accessing the local datasets is not an option, since the worker nodes of a federation are not allowed to share raw data and are instead only allowed to share parameters of the machine learning models that they train with a master node. Besides, even if it were possible, regrouping worker nodes upon any change to the local datasets of those worker nodes can be complex and can again require manual work.

There also exist techniques that actively manage worker nodes based on resource conditions on those worker nodes to reduce the training time in a federated learning setting. These techniques aim to aggregate as many client updates as possible within a specified time period. However, setting this time period too short or too long can result in various consequences and thus trade-offs need to be made.

### SUMMARY

It is thus an object of the disclosure to obviate or eliminate at least some of the above-described disadvantages associated with existing techniques.

Therefore, according to an aspect of the disclosure, a method is performed by a master node for managing training of a machine learning model. The method comprises selecting one or more worker nodes of a plurality of worker nodes to train a machine learning model in a round of training. The one or more worker nodes are selected to optimise a performance of an updated machine learning model for a validation dataset after the round of training. The updated machine learning model has one or more parameters of the machine learning model trained by the one or more worker nodes in a previous round of training.

In this way, an advantageous technique for managing training of a machine learning model is provided. The technique operates as a federated machine learning technique but is improved over the existing federated machine learning techniques, since it optimises an updated machine learning model by way of a reinforcement learning process. In particular, the technique advantageously selects one or more worker nodes for training based on which of the plurality worker nodes will improve the performance of the machine learning model in the future. The technique uses one or more parameters of the machine learning model trained by the one or more worker nodes in a previous round of training for the updated machine learning model, which means that the technique is dynamic in that it can optimise the performance of the updated machine learning model depending on what has been learnt from previous training rounds. The privacy of datasets can also be maintained, since the raw datasets do not need to be shared for the technique to operate. Moreover, the technique does not require extensive pre-processing, complex operations, or any manual work. The technique is thus more efficient and more accurate than the existing federated machine learning techniques.

In some embodiments, selecting the one or more worker nodes may comprise selecting a mask indicative of the one or more worker nodes.

In some embodiments, the mask may be a binary vector comprising a value of one to indicate the one or more worker nodes and a value of zero to indicate any other worker nodes of the plurality of worker nodes.

In some embodiments, the one or more worker nodes may be selected to optimise the performance of the updated machine learning model by selecting the one or more worker nodes that maximise a reward for the performance of the updated machine learning model.

In some embodiments, the reward for the performance of the updated machine learning model may be maximised if it is determined to be higher than a reward for a performance of the machine learning model in a previous round of training.

In some embodiments, the reward for the performance of the updated machine learning model may be based on a performance metric for each of the one or more worker nodes that is indicative of a performance of the worker node.

In some embodiments, the method may comprise receiving the performance metric from each of the one or more worker nodes.

In some embodiments, the one or more parameters of the updated machine learning model may comprise an aggregation of the one or more parameters of the machine learning model trained by the one or more worker nodes in the previous round of training.

In some embodiments, the method may comprise aggregating the one or more parameters of the machine learning model trained by the one or more worker nodes in the previous round of training.

In some embodiments, the aggregation may be an average.

In some embodiments, the selection may be performed for at least one worker node of the plurality of worker nodes and, for each worker node for which the selection is performed, the one or more worker nodes may be selected to optimise the performance of the updated machine learning model for that worker node. In this way, the performance of the updated machine learning model can be optimised for a particular worker node. That is, a more specialised machine learning model can be learnt for a specific worker node, rather than a machine learning model that is supposed to fit data for all worker nodes.

In some embodiments, the selection may be performed for at least two worker nodes of the plurality of worker nodes simultaneously.

In some embodiments, for each worker node for which the selection is performed, the validation dataset may be a validation dataset of that worker node.

In some embodiments, the method may comprise initiating transmission of the one or more parameters of the machine learning model trained by the one or more worker nodes in the previous round of training towards the one or more worker nodes for the one or more worker nodes to further train the updated machine learning model.

In some embodiments, the method may comprise repeating the method until a point of convergence is reached.

In some embodiments, the point of converge may be reached when a predefined minimum number of training rounds is completed and/or an increase in the performance of the updated machine learning model for the validation dataset is less than a predefined threshold.

In some embodiments, the method may comprise, prior to selecting the one or more worker nodes, initiating transmission of one or more parameters of the machine learning model towards the one or more worker nodes for the one or more worker nodes to train the machine learning model in the previous round of training and receiving the one or more parameters of the machine learning model trained by the one or more worker nodes in the previous round of training from the one or more worker nodes.

In some embodiments, the method may comprise selecting a weighting for the one or more worker nodes that controls the amount by which each of the one or more worker nodes contributes to training the machine learning model in the round of training, wherein the weighting may be selected to optimise the performance of the updated machine learning model for the validation dataset after the round of training.

In some embodiments, the weighting may be selected based on a state of the one or more worker nodes.

In some embodiments, the method may comprise checking the state of the one or more worker nodes.

In some embodiments, the plurality of worker nodes may be distributed at different geographical locations.

In some embodiments, the machine learning model may be trained to predict one or more events in a telecommunications network.

In some embodiments, the method may comprise applying the trained machine learning model to predict one or more events in the telecommunications network.

In some embodiments, the one or more events in the telecommunications network may comprise degradation in a key performance indicator of the telecommunications network and/or a fault in the telecommunications network.

In some embodiments, the master node and/or one or more of the plurality of worker nodes may be nodes of a telecommunications network.

In some embodiments, the master node may be an operations support system (OSS) node or a regional data center, and/or at least one of the plurality of worker nodes may be a base station and/or at least one of the plurality of worker nodes may be a local data center.

According to another aspect of the disclosure, there is provided a master node configured to operate in accordance with the method described earlier. The master node thus provides the advantages described earlier.

In some embodiments, the master node may comprise processing circuitry configured to operate in accordance with the method described earlier.

In some embodiments, the master node may comprise at least one memory for storing instructions which, when executed by the processing circuitry, cause the master node to operate in accordance with the method described earlier.

According to another aspect of the disclosure, there is provided a system comprising the master node as described earlier and any one or more of the plurality of worker nodes. The system thus provides the advantages described earlier.

According to another aspect of the disclosure, there is provided a computer program comprising instructions which, when executed by processing circuitry, cause the processing circuitry to perform the method described earlier. The computer program thus provides the advantages described earlier.

According to another aspect of the disclosure, there is provided a computer program product, embodied on a non-transitory machine-readable medium, comprising instructions which are executable by processing circuitry to cause the processing circuitry to perform the method described earlier. The computer program product thus provides the advantages described earlier.

Therefore, an advantageous technique for managing training of a machine learning model is provided.

### BRIEF DESCRIPTION OF THE DRAWINGS

For a better understanding of the technique, and to show how it may be put into effect, reference will now be made, by way of example, to the accompanying drawings, in which:

FIG. 1 is a block diagram illustrating a master node according to an embodiment;

FIG. 2 is a flowchart illustrating a method performed by a master node according to an embodiment;

FIG. 3 is a flowchart illustrating a method performed by a master node according to an embodiment;

FIG. 4 is an example of a plurality of worker nodes;

FIG. 5 is an example of a plurality of worker nodes;

FIG. 6 is a signalling diagram illustrating an exchange of signals in a system according to an embodiment; and

FIG. 7 is a signalling diagram illustrating an exchange of signals in a system according to an embodiment.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

As mentioned earlier, an advantageous technique for managing training of a machine learning model is described herein. The method described herein can be implemented by a master node. The master node communicates with one or more worker nodes of a plurality of worker nodes to implement the method described herein. The master node and the plurality of worker nodes can communicate (e.g. transmit information to each other) over a communication channel. In some embodiments, the master node and the plurality of worker nodes may communicate over the cloud. The method described herein can be implemented in the cloud according to some embodiments.

The plurality of worker nodes referred to herein can be distributed at different geographical locations or at least some (or all) of the worker nodes of the plurality of worker nodes referred to herein can be at the same geographical location. In some embodiments, the master node referred to herein and/or any one or more of the plurality of worker nodes referred to herein may be a node of a network or, more specifically, a node of a telecommunications network. The telecommunications network can, for example, be a mobile network, such as a fourth generation (4G) mobile network, a fifth generation (5G) mobile network, a sixth generation (6G) mobile network, or any other generation mobile network. In some embodiments, the telecommunications network can be a core network, such as a mobile core network. The network may, for example, be a radio access network (RAN), or any other type of telecommunications network.

Thus, in some embodiments, the master node referred to herein and/or any one or more of the plurality of worker nodes referred to herein may be a network node. For example, in some embodiments, at least one of the plurality of worker nodes referred to herein may be a base station (e.g. a radio base station, a Node B, an evolved Node B (eNB), a new radio NR NodeB (gNBs), or any other base station) and/or at least one of the plurality of worker nodes referred to herein may be a local data center. In this way, at least one of the plurality of worker nodes referred to herein can operate in a decentralized manner. Alternatively or in addition, in some embodiments, the master node referred to herein may be an operations support system (OSS) node or a regional data center. In this way, the master node referred to herein can operate in a centralized manner.

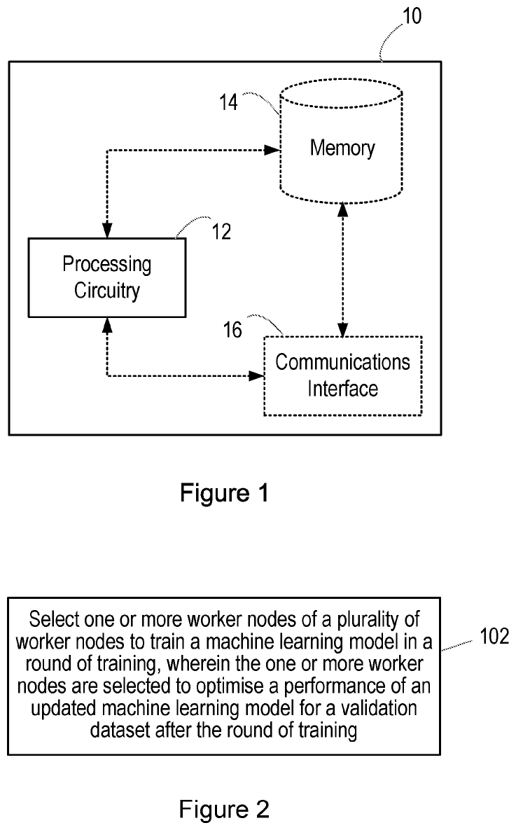

FIG. 1 illustrates a master node 10 in accordance with an embodiment. The master node 10 is for managing training of a machine learning model. The master node 10 referred to herein can refer to equipment capable, configured, arranged and/or operable to communicate directly or indirectly with one or more worker nodes, and/or with other network nodes or equipment to enable and/or to perform the functionality described herein. The master node 10 referred to herein may be a physical node (e.g. a physical machine) or a virtual node (e.g. a virtual machine, VM).

As illustrated in FIG. 1, the master node 10 comprises processing circuitry (or logic) 12. The processing circuitry 12 controls the operation of the master node 10 and can implement the method described herein in respect of the master node 10. The processing circuitry 12 can be configured or programmed to control the master node 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the master node 10. In some embodiments, the processing circuitry 12 can be configured to run software to perform the method described herein in respect of the master node 10. The software may be containerised according to some embodiments. Thus, in some embodiments, the processing circuitry 12 may be configured to run a container to perform the method described herein in respect of the master node 10.

Briefly, the processing circuitry 12 of the master node 10 is configured to select one or more worker nodes of a plurality of worker nodes to train a machine learning model in a round of training. The one or more worker nodes are selected to optimise a performance of an updated machine learning model for a validation dataset after the round of training. The updated machine learning model has one or more parameters of the machine learning model trained by the one or more worker nodes in a previous round of training.

The machine learning model referred to herein can be any type of machine learning model. Examples of a machine learning model include, but are not limited to, a neural network, a decision tree, or any other type of machine learning model. The one or more parameters referred to herein may also be referred to in the art as one or more model parameters. A model parameter is a configuration variable that is internal to the machine learning model. Examples of model parameters include, but are not limited to, weights (e.g. in a neural network), vectors (e.g. support vectors in a support vector machine), coefficients (e.g. in a linear or logistic regression), etc. Herein, a machine learning model may be trained using any machine learning algorithm (or process). Examples of a machine learning algorithm include, but are not limited to, a linear regression algorithm, a logistic regression algorithm, a decision tree algorithm, a neural network algorithm, or any other machine learning algorithm.

As illustrated in FIG. 1, in some embodiments, the master node 10 may optionally comprise a memory 14. The memory 14 of the master node 10 can comprise a volatile memory or a non-volatile memory. In some embodiments, the memory 14 of the master node 10 may comprise a non-transitory media. Examples of the memory 14 of the master node 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the master node 10 can be connected to the memory 14 of the master node 10. In some embodiments, the memory 14 of the master node 10 may be for storing program code or instructions which, when executed by the processing circuitry 12 of the master node 10, cause the master node 10 to operate in the manner described herein in respect of the master node 10. For example, in some embodiments, the memory 14 of the master node 10 may be configured to store program code or instructions that can be executed by the processing circuitry 12 of the master node 10 to cause the master node 10 to operate in accordance with the method described herein in respect of the master node 10. Alternatively or in addition, the memory 14 of the master node 10 can be configured to store any information, data, messages, requests, responses, indications, notifications, signals, or similar, that are described herein. The processing circuitry 12 of the master node 10 may be configured to control the memory 14 of the master node 10 to store information, data, messages, requests, responses, indications, notifications, signals, or similar, that are described herein.

In some embodiments, as illustrated in FIG. 1, the master node 10 may optionally comprise a communications interface 16. The communications interface 16 of the master node 10 can be connected to the processing circuitry 12 of the master node 10 and/or the memory 14 of master node 10. The communications interface 16 of the master node 10 may be operable to allow the processing circuitry 12 of the master node 10 to communicate with the memory 14 of the master node 10 and/or vice versa. Similarly, the communications interface 16 of the master node 10 may be operable to allow the processing circuitry 12 of the master node 10 to communicate with any one or more of the plurality of worker nodes referred to herein and/or any other nodes referred to herein. The communications interface 16 of the master node 10 can be configured to transmit and/or receive information, data, messages, requests, responses, indications, notifications, signals, or similar, that are described herein. In some embodiments, the processing circuitry 12 of the master node 10 may be configured to control the communications interface 16 of the master node 10 to transmit and/or receive information, data, messages, requests, responses, indications, notifications, signals, or similar, that are described herein.

Although the master node 10 is illustrated in FIG. 1 as comprising a single memory 14, it will be appreciated that the master node 10 may comprise at least one memory (i.e. a single memory or a plurality of memories) 14 that operate in the manner described herein. Similarly, although the master node 10 is illustrated in FIG. 1 as comprising a single communications interface 16, it will be appreciated that the master node 10 may comprise at least one communications interface (i.e. a single communications interface or a plurality of communications interface) 16 that operate in the manner described herein. It will also be appreciated that FIG. 1 only shows the components required to illustrate an embodiment of the master node 10 and, in practical implementations, the master node 10 may comprise additional or alternative components to those shown.

Although not illustrated, it will be appreciated that any one or more of the plurality of worker nodes referred to herein may comprises one or more of the same components as the master node 10 as described with reference to FIG. 1.

FIG. 2 is a flowchart illustrating a method performed by a master node 10 in accordance with an embodiment. The method is for managing training of a machine learning model. The master node 10 described earlier with reference to FIG. 1 can be configured to operate in accordance with the method of FIG. 2. The method can be performed by or under the control of the processing circuitry 12 of the master node 10 according to some embodiments. In some embodiments, an agent may be employed at the master node 10 to execute the method.

With reference to FIG. 2, as illustrated at block 102, one or more worker nodes of a plurality of worker nodes are selected to train a machine learning model in a round of training. More specifically, the processing circuitry 12 of the master node 10 can select one or more worker nodes according to some embodiments. The one or more worker nodes are selected to optimise a performance of an updated machine learning model for a validation dataset after the round of training. The updated machine learning model has one or more parameters of the machine learning model trained by the one or more worker nodes in a previous round of training.

The method operates as a federated machine learning technique but the method is improved over existing federated machine learning techniques, since it optimises an updated machine learning model by way of a reinforcement learning process. In particular, the technique advantageously selects one or more worker nodes for training based on which of the plurality worker nodes will improve the performance of the machine learning model in the future.

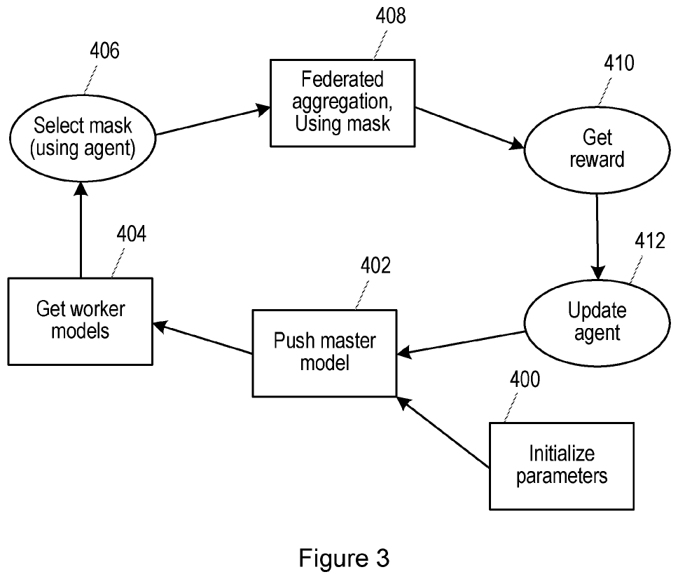

FIG. 3 is a flowchart illustrating a method performed by a master node 10 in accordance with an embodiment. The method is for managing training of a machine learning model. The master node 10 described earlier with reference to FIG. 1 can be configured to operate in accordance with the method of FIG. 3. The method can be performed by or under the control of the processing circuitry 12 of the master node 10 according to some embodiments. In some embodiments, an agent may be employed at the master node 10 to execute the method.

As illustrated at block 400, in some embodiments, the method may comprise initiating a machine learning model, e.g. by initiating one or more parameters of a machine learning model. More specifically, the processing circuitry 12 of the master node 10 can be configured to initialise the machine learning model according to some embodiments. As illustrated at block 402 of FIG. 3, in some embodiments, the method may comprise initiating transmission of one or more parameters of the machine learning model towards the one or more worker nodes for the one or more worker nodes to train the machine learning model in a round of training. This round of training will be referred to herein as a “previous” round of training, since at least one subsequent round of training can also be performed.

In some embodiments, the processing circuitry 12 of the master node 10 can be configured to initiate the transmission of the one or more parameters of the machine learning model. Herein, the term “initiate” can mean, for example, cause or establish.

Thus, the processing circuitry 12 of the master node 10 can be configured to, e.g. via a communications interface 16 of the master node 10, itself transmit the one or more parameters of the machine learning model or can be configured to cause another node to transmit the one or more parameters of the machine learning model. The transmission of the one or more parameters of the machine learning model can be initiated prior to selecting one or more worker nodes.

The one or more worker nodes can train the machine learning model in this previous round of training and initiate transmission of (e.g. themselves transmit or cause another node to transmit) one or more parameters of the trained machine learning model towards the master node 10. Thus, as illustrated at block 404 of FIG. 3, in some embodiments, the method may comprise receiving the one or more parameters of the machine learning model trained by the one or more worker nodes in the previous round of training from the one or more worker nodes. More specifically, the processing circuitry 12 of the master node 10 can be configured to receive, e.g. via a communications interface 16 of the master node 10, the one or more parameters of the machine learning model trained by the one or more worker nodes in the previous round of training from the one or more worker nodes according to some embodiments.

As illustrated by block 406 of FIG. 3, one or more worker nodes of a plurality of worker nodes are selected to train (e.g. contribute to the training of) the machine learning model in a round of training. The one or more worker nodes are selected to optimise a performance of an updated machine learning model for a validation dataset after the round of training. The updated machine learning model has one or more parameters of the machine learning model trained by the one or more worker nodes in a previous round of training. In the case where more than one worker node is selected, the selected worker nodes can be grouped into a federation.

In more detail, at block 406 of FIG. 3, selecting the one or more worker nodes can comprise selecting a mask indicative of the one or more worker nodes according to some embodiments. More specifically, the processing circuitry 12 of the master node 10 can be configured to select this mask according to some embodiments. Thus, in some embodiments, it may be the mask that is selected to optimise the performance of the updated machine learning model for the validation dataset after the round of training. As the mask is selected in this way, it is not necessary to employ manual effort to select the mask or to try every possible mask (and thus every possible worker node and every possible combination of worker nodes).

In some embodiments, the mask referred to herein may be a vector. For example, the mask referred to herein may be a binary vector comprising a value of one to indicate the one or more worker nodes and a value of zero to indicate any other worker nodes of the plurality of worker nodes. In some embodiments, the mask may be acquired from the master node 10 itself, e.g. from a memory 14 of the master node 10. Thus, according to some embodiments, the aim of the master node 10 can be to learn a mask that can include and/or exclude certain worker nodes (e.g. to build a sub-federation) to optimise the performance and thus maximise the accuracy of a machine learning model trained by a worker node.

In some embodiments, the one or more worker nodes may be selected to optimise the performance of the updated machine learning model by selecting the one or more worker nodes that maximise a reward for the performance of the updated machine learning model. In some embodiments, the reward for the performance of the updated machine learning model may be maximised if it is determined to be higher than a reward for a performance of the machine learning model in a previous round of training. Thus, the reward for the performance of the updated machine learning model can be dependent on the machine learning model at the previous state. The reward can be a function of the performance, the performance itself (e.g. where large performance is good), or a function of the history of the performance (e.g. how much improvement is seen between the training rounds).

In some embodiments, the selection of the one or more worker nodes may be performed for at least one worker node of the plurality of worker nodes or even each worker node of the plurality of worker nodes. For example, for at least one worker node, or for each worker node, the benefits from all other worker nodes may be explored. In some embodiments, the one or more selected worker nodes may comprise the worker node for which the selection is performed and/or at least one other worker node. In the case where one or more other worker nodes are selected for a particular worker node, the one or more other selected worker nodes and the particular worker node can be grouped into a federation. In some embodiments, all worker nodes may be grouped into a federation, e.g. at least in the early (exploration) phase of the learning process.

In these embodiments, for each worker node for which the selection is performed, the one or more worker nodes can be selected to optimise the performance of the updated machine learning model for that worker node. Thus, the master node 10 can aim to optimise the performance of the updated machine learning model for individual worker nodes. In this way, the accuracy achieved by each individual worker node is maximised. The machine learning model can be fine-tuned for individual worker nodes, as opposed to finding a compromise for all worker nodes. In some embodiments, the selection of the one or more worker nodes may be performed for at least two worker nodes of the plurality of worker nodes in parallel and/or simultaneously. Thus, according to some embodiments, parallel federations can be trained at the same time.

In some embodiments, for each worker node for which the selection of the one or more worker nodes is performed, the validation dataset may be a validation dataset of that worker node. In some of these embodiments, the validation dataset may be located at (i.e. local to) that worker node and/or unique to that worker node.

Although not illustrated in FIG. 3, in some embodiments, the method may comprise selecting a weighting for the one or more worker nodes that controls the amount by which each of the one or more worker nodes contributes to training the machine learning model in the round of training. More specifically, the processing circuitry 12 of the master node 10 can be configured to select the weighting for the one or more worker nodes according to some embodiments. In these embodiments, the weighting can be selected to optimise the performance of the updated machine learning model for the validation dataset after the round of training. In some embodiments, the weighting may be selected based on a state of the one or more worker nodes. Thus, in some embodiments, although not illustrated in FIG. 3, the method may comprise checking the state of the one or more worker nodes. More specifically, the processing circuitry 12 of the master node 10 can be configured to check the state of the one or more worker nodes according to some embodiments. In embodiments involving a mask, the mask can be indicative of the one or more worker and the weighting for the one or more worker nodes.

In some embodiments, for each worker node for which the selection is performed, the one or more worker nodes can be selected to optimise the performance of the updated machine learning model for that worker node according to the following equation:

Min{Lossₙ Federation(wₒMₒ,w₁M₁, . . . ,wₙMₙ)} for all worker nodes n,

where w is a mask in the form of a matrix indicative of a weighting for each worker node that controls the amount by which one or more worker nodes contribute to training the machine learning model in the round of training and M is a mask in the form of a (e.g. binary) vector indicative of which one or more of the plurality of worker nodes are selected. The goal of this equation is to, for each worker node, minimise (e.g. as much as possible) the prediction (or estimation) loss of the machine learning model trained by that worker node using the corresponding mask w indicative of the weighting for that worker node. In embodiments where a weighting is not used, the weights in the matrix can be set to 1.

In some embodiments, the one or more parameters of the updated machine learning model referred to herein may comprise an aggregation of the one or more parameters of the machine learning model trained by the one or more worker nodes in the previous round of training. Thus, as illustrated by block 408 of FIG. 3, in some embodiments, the method may comprise aggregating the one or more parameters of the machine learning model trained by the one or more worker nodes in the previous round of training. More specifically, the processing circuitry 12 of the master node 10 can be configured to aggregate the one or more parameters of the machine learning model trained by the one or more worker nodes in the previous round of training according to some embodiments. In some embodiments, the aggregation may be an average. In embodiments involving a mask, the aggregation can be based on the mask.

For example, for n worker nodes, there may be a mask m indicative of which one or more of the plurality of worker nodes are selected. As previously mentioned, this mask can be a binary vector comprising ones and zeros. The binary vector can be of length n. For the binary vector, the ith element in the binary vector indicates whether or not to include the ith worker node. There can exist one binary vector or other mask for each federation. The number of possible masks (and thus federations) can range from 1 to 2ⁿ−1. For n worker nodes, there may also be a mask w indicative of how much weight to give to each worker node. This mask w can, for example, be a matrix. In some embodiments where the aggregation is an average, the average of the one or more parameters of the machine learning model trained by the one or more worker nodes in the previous round of training may be determined using the following equation:

$$Average = \frac{1}{n} {\sum }_{i = 0}^{n} {w}_{i} {m}_{i} ,$$

where i is the worker node identity (id), w is a matrix indicative of how much weight to give to each worker node when averaging the one or more parameters of the machine learning model trained by the one or more worker nodes in the previous round of training, and m is a binary vector indicative of which one or more of the plurality of worker nodes are selected. Only the worker node, or worker nodes, that are flagged with 1 in the binary vector are involved in the aggregation. The sum of the weights for the one or more selected worker nodes is divided by the number n of worker nodes involved in the aggregation. In embodiments where a weighting is not used, the weights in the matrix can be set to 1.

As mentioned earlier, in some embodiments, the one or more worker nodes may be selected to maximise a reward for the performance of the updated machine learning model and the reward may be maximised if it is determined to be higher than a reward for a performance of the machine learning model in a previous round of training. Thus, in some embodiments, as illustrated at block 410 of FIG. 3, the method may comprise determining a reward for the performance of the updated machine learning model. More specifically, the processing circuitry 12 of the master node 10 can be configured to determine the reward according to some embodiments. The reward referred to herein may also be referred to as a reward signal.

The reward can be a function of the validation performance for a specific worker node or a specific combination of worker nodes. In some embodiment, the master node 10 may aim to maximise the reward for the performance of the updated machine learning model on one or more parts of (e.g. data target variable intervals in) the validation dataset. In embodiments where the method is performed for a worker node, the one or more parts of the validation dataset can be one or more parts of the dataset in which the worker node is most interested. This can be the case for each worker node. For example, if for a worker node, the accuracy of some part of the validation dataset (e.g. between y_{lower bound}<y<y_{upper bound}) is more important than the accuracy of the rest of the validation dataset, then the master node 10 may have the goal to weight the reward more on that part of the validation dataset (e.g. between y_{lower bound} and y_{upper bound}).

In some embodiments, the reward may be indicative of the performance of some function of the history of performances, such as an improvement in performance between training rounds. In some embodiments, the reward for the performance of the updated machine learning model may be based on a performance metric for each of the one or more worker nodes that is indicative of a performance of the worker node. In some of these embodiments, although not illustrated in FIG. 3, the method may comprise receiving the performance metric from each of the one or more worker nodes. More specifically, the processing circuitry 12 of the master node 10 can be configured to receive (e.g. via a communications interface 16 of the master node 10) the performance metric from each of the one or more worker nodes according to some embodiments. For example, in some embodiments, the performance metric from each of the one or more worker nodes may be received with the one or more parameters of the machine learning model trained by the one or more worker nodes at block 404 of FIG. 3. The performance metric can be any performance metric and a person skilled in the art will be aware of various examples, e.g. an area under curve (AUC) performance metric.

In some embodiments, as illustrated by block 412 of FIG. 3, the method may comprise updating the master node 10. More specifically, the processing circuitry 12 of the master node 10 can be configured to update itself according to some embodiments. The update of the master node 10 can, for example, comprise storing the updated machine learning model in a memory 14 of the master node 10 and/or updating a policy (e.g. value functions and/or action-value functions) used to select the one or more parameters (or the mask) for a given state, such that the overall performance is optimised.

The method described with reference to FIG. 3 may be repeated. Thus, the method can run in a loop according to some embodiments. For example, at block 402 of FIG. 3, the method may comprise initiating transmission of the one or more parameters of the machine learning model trained by the one or more worker nodes in the previous round of training towards the one or more worker nodes for the one or more worker nodes to further train the updated machine learning model. The subsequent steps of the method illustrated at blocks 404 to 412 may then be performed.

In some embodiments, the method described with reference to FIG. 3 may be repeated until a point of convergence is reached. A point of converge may, for example, be reached when a predefined minimum number of training rounds is completed and/or an increase in the performance of the updated machine learning model for the validation dataset is less than a predefined threshold. In embodiments where the selection of the one or more worker nodes is performed for at least two worker nodes of the plurality of worker nodes simultaneously and/or in parallel, faster convergence can be enabled.

In embodiments where the method is performed for at least one worker node of the plurality of worker nodes and repeated for the at least one worker node, eventually, it can be the case that the at least one worker node is prevented from receiving parameters from irrelevant worker nodes whose parameters do not optimise the performance of the at least one worker node and that may thus potentially reduce the accuracy of the at least one worker node. It may be the case that there is a mutual benefit where all worker nodes benefit from federation or it may be the case that some worker nodes benefit from federation while others do not (e.g. in that their performance is not optimised and thus their accuracy is not improved or is even reduced by being part of a federation). That is, some worker nodes in a federated learning setting may benefit from being part of a federation, while other worker nodes may not. This may be dependent on the local validation datasets for individual worker nodes. There can be some worker nodes that benefit most from isolated training, without using parameters from machine learning models trained by other worker nodes.

Thus, it is the task of the master node 10 to find the particular worker node, or the particular combination of worker nodes, that is best and the master node 10 can do this in the manner described earlier with reference to FIG. 3. In the manner described earlier with reference to FIG. 3, according to some embodiments, the best worker node or the best combination of worker nodes can be found by exploring the different worker nodes and combinations of worker nodes, observing the rewards, and selecting the best worker node(s) accordingly. In some embodiments involving a policy, the policy used to select the one or more parameters (or the mask) for a given state, such that the overall performance is optimised, can be adjusted following the selection. This means that worker nodes may join and leave the federation according to the decisions taken by the master node 10 during training but, in the end, the optimal worker node or combination of worker nodes will be reached (e.g. at the point of convergence).

In some embodiments, a federation graph may be generated, e.g. after the point of convergence mentioned earlier. A federation graph is a graph that represents the worker nodes in a federation. A federation graph can be generated, for example, if it is assumed that the optimum worker node or the optimum combination of worker nodes does not change as the state of the federation changes. A directed edge within the federation graph can be indicative of which worker node benefits another worker node in training a machine learning model. A bidirectional edge in the federation graph can be indicative of a mutual benefit between worker nodes.

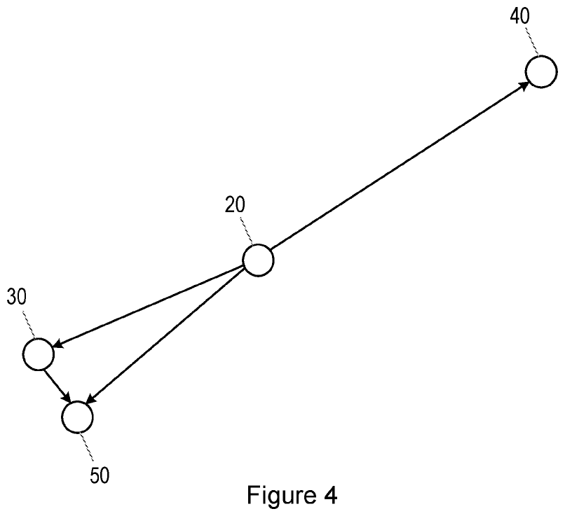

FIG. 4 illustrates an example of such a federation graph. As illustrated in FIG. 4, the plurality of worker nodes 20, 30, 40, 50 according to this example comprise four worker nodes, namely a first worker node 20, a second worker node 30, a third worker node 40, and a fourth worker node 50. However, it will be understood that this is only one example and other examples may involve a different number of worker nodes. The federation graph represents which worker nodes are in a federation.

The directed edges in the federation graph are indicative of which worker nodes benefit other worker nodes in training a machine learning model, with the bidirectional edge in the federation graph being indicative of a mutual benefit between worker nodes. Thus, the directed edges in the federation graph can be indicative of which worker nodes contribute (by way of their machine learning model parameters) to the training of the machine learning model by another worker node. If the method described herein is performed for more than one worker node of the plurality of worker nodes, then there can be a plurality of different (parallel) federations for each of these worker nodes as illustrated by the example in FIG. 4.

In the example illustrated in FIG. 4, the federation for the third worker node 40 is where the first worker node 20 and the third worker node 40 contribute (by way of their machine learning model parameters) to the training of the machine learning model by the third worker node 40. In this federated learning setting, the third worker node 40 achieves its optimum performance and thus maximum accuracy. In the example illustrated in FIG. 4, the federation for the second worker node 30 is a parallel federation where the first worker node 20 and the second worker node 30 contribute (by way of their machine learning model parameters) to the training of the machine learning model by the second worker node 30. In this federated learning setting, the second worker node 20 achieves its optimum performance and thus maximum accuracy. In the example illustrated in FIG. 4, the federation for the fourth worker node 50 is another parallel federation where the first worker node 20, the second worker node 30, and the fourth worker node 50 contribute (by way of their machine learning model parameters) to the training of the machine learning model by the fourth worker node 50. In this federated learning setting, the fourth worker node 50 achieves its optimum performance and thus maximum accuracy. In the example illustrated in FIG. 4, the first worker node 20 does not benefit from any other worker node. Thus, the first worker node 20 trains the machine learning model in an isolated manner.

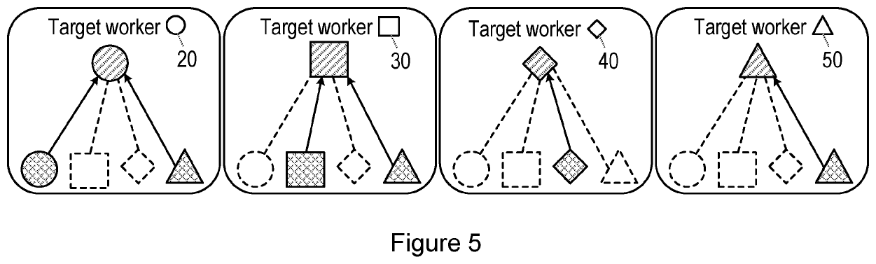

FIG. 5 illustrates an example of a contribution of one or more worker nodes to the training of a machine learning model by a given worker node. In the example illustrated in FIG. 5, the training by the different worker nodes is running in parallel. Each worker node 20, 30, 40, 50 has a local (e.g. and unique) validation dataset. For each worker node 20, 30, 40, 50, the master node 10 (which is not illustrated in FIG. 5) aims to optimise the performance of the machine learning model for a specific validation dataset in each box of FIG. 5 in the manner described herein. In the example illustrated in FIG. 5, all four worker nodes 20, 30, 40, 50 are trained and aggregated with the machine learning model parameters from different worker nodes and different combinations of worker nodes.

For each worker node 20, 30, 40, 50, the worker node or combination of worker nodes that optimise the performance of the machine learning model for the validation dataset of that target worker node is selected. In each box in FIG. 5, for the target worker node 20, 30, 40, 50 illustrated, the worker node(s) with a solid outline are selected for that target worker node 20, 30, 40, 50, whereas the worker node(s) with a dashed outline are not selected for that target worker node. Thus, it can be seen that the first worker node 20 and the fourth worker node 50 are selected where the first worker node 20 is the target worker node, the second worker node 30 and the fourth worker node 50 are selected where the second worker node 30 is selected, the third worker node 40 is selected where the third worker node 40 is the target worker node, and the fourth worker node 50 is selected where the fourth worker node 50 is the target worker node. Each target worker node 20, 30, 40, 50 is trained and aggregated with the machine learning model parameters from the selected worker node(s) in order to optimise the performance of the machine learning model and thus yield the highest accuracy.

As mentioned earlier, the method described herein operates as a federated machine learning technique but the method is improved over existing federated machine learning techniques, since it optimises an updated machine learning model by way of a reinforcement learning process. In particular, the technique advantageously selects one or more worker nodes for training based on which of the plurality worker nodes will improve the performance of the machine learning model in the future.

In the art of machine learning, a Markov Decision Process (MDP) is the mathematical framework around which reinforcement learning is built. There is a learner and a decision maker, which is also referred to in the art as an agent. The decision maker interacts with the learner and takes decisions on how to optimise performance. There is generally also a set of actions A, a set of states S and a set of observations O. The set of actions are the actions that the agent can perform. The set of states are the states of the agent in the environment where the agent learns and decides what actions to perform. All necessary information about the state of a system is known from just the latest state. This is referred to in the art as the Markov property. The observations are observations of the underlying state. The observations may not convey all information that is in a single state. If the observations do not convey all information about the state, the MDP is said to be a Partially Observed Markov Decision Process (POMDP) and then the system does not satisfy the Markov property.

An MDP can be employed in the method described herein. In this respect, in the method described herein, each of the plurality of worker nodes is a learner, the master node 10 (or an agent at the master node 10) is the decision maker, and the state is the machine learning model that is updated by the master node 10. The action can be the mask that the master node 10 (or agent of the master node 10) may learn. The method described herein can be posed as a single state problem according to some embodiments and thus no state needs to be measured. However, in other embodiments, the method described herein may be posed as a full MDP, where each action can change an underlying state and different actions can have different values in different states.

If the method described herein is posed as a full MDP with multiple states, the state may be the one or more parameters of the machine learning model according to some embodiments. However, in other embodiments, the master node 10 may instead simply learn whether or not to include the parameter(s) of a worker node and then the state can be a moving average of the parameter(s) of other worker nodes in the federation. This can show an approximation of where the master node 10 is in the mask according to embodiments involving a mask. During the learning process, the master node 10 may update a policy that is used to select the one or more parameters (or the mask) for a given state, such that the overall performance is optimised.

There is also provided a system. The system is for managing training of a machine learning model. The system comprises the master node 10 described earlier and any one or more of the plurality of worker nodes.

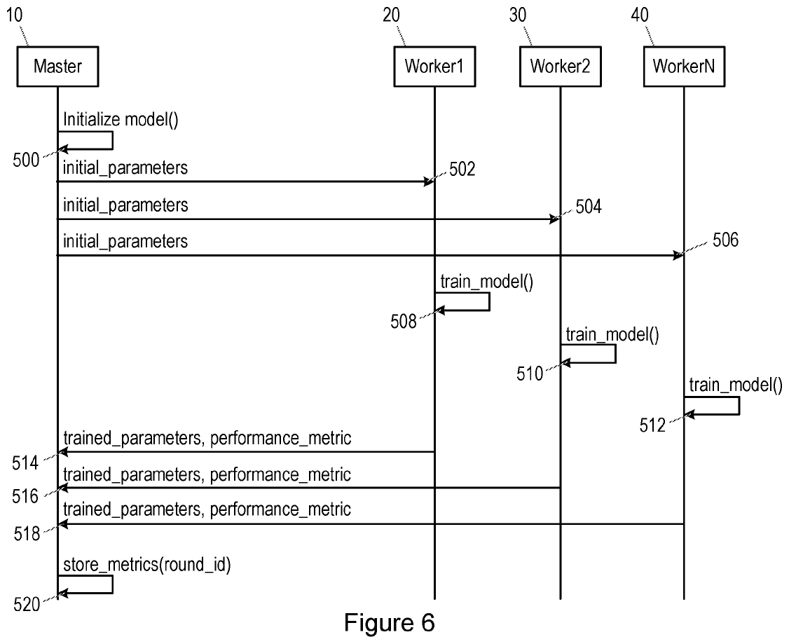

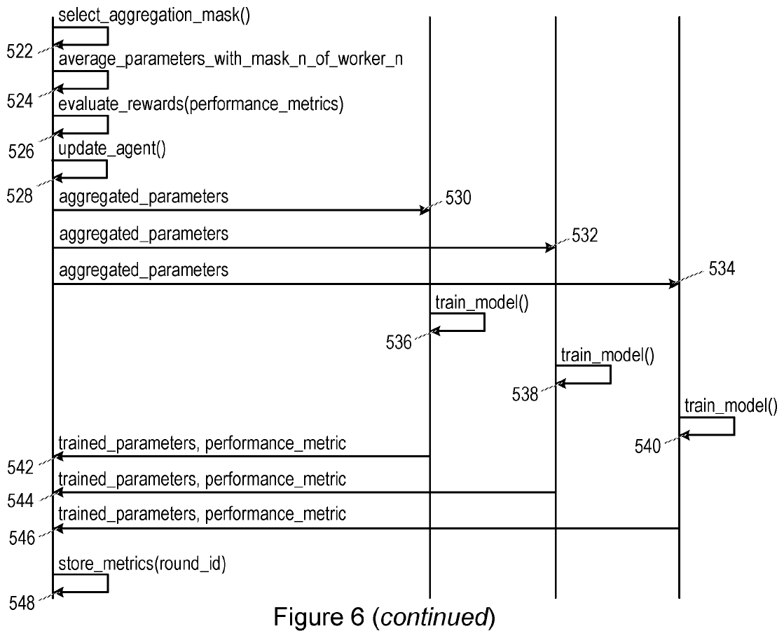

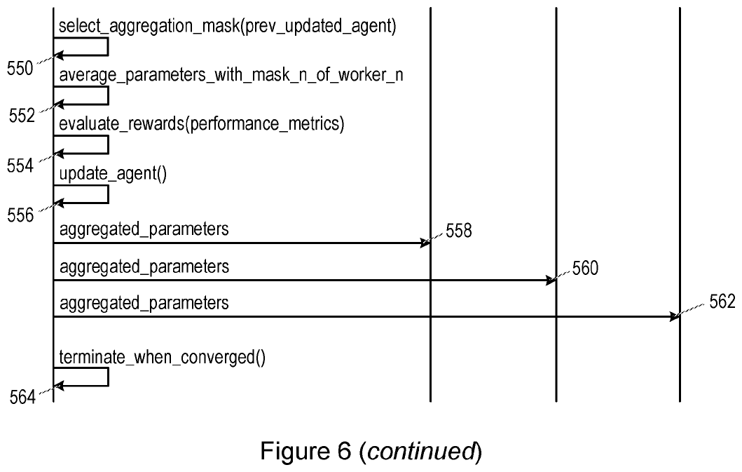

FIG. 6 is a signalling diagram illustrating an exchange of signals in such a system according to an embodiment. The system illustrated in FIG. 6 comprises the master node 10 described earlier and the plurality of worker nodes 20, 30, 40.

As illustrated by arrow 500 of FIG. 6, the master node 10 may initiate a machine learning model (as described earlier with reference to block 400 of FIG. 3). As illustrated by arrows 502, 504, 506 of FIG. 6, the master node 10 may initiate transmission of (e.g. itself transmits) one or more parameters of the machine learning model towards one or more worker nodes 20, 30, 40 (as described earlier with reference to block 402 of FIG. 3) for the one or more worker nodes 20, 30, 40 to train the machine learning model in a round of training. As before, this round of training will be referred to as a “previous” round of training, since at least one subsequent round of training is also performed. As illustrated by arrows 508, 510, 512 of FIG. 6, the one or more worker nodes 20, 30, 40 may train the machine learning model in this previous round of training.

As illustrated by arrows 514, 516, 518 of FIG. 6, the one or more worker nodes 20, 30, 40 may initiate transmission of (e.g. themselves transmit) one or more parameters of the trained machine learning model towards the master node 10. Thus, the master node 10 may receive the one or more parameters of the machine learning model trained by the one or more worker nodes in the previous round of training from the one or more worker nodes (as described earlier with reference to block 404 of FIG. 3). As also illustrated by arrows 514, 516, 518 of FIG. 6, each of the one or more worker nodes 20, 30, 40 may also initiate transmission of (e.g. themselves transmit) a performance metric that is indicative of a performance of the worker node towards the master node 10. Thus, the master node 10 may also receive a performance metric for each of the one or more worker nodes that is indicative of a performance of the worker node. As illustrated by arrow 520 of FIG. 6, in some embodiments, the master node 10 may store the performance metric for each of the one or more worker nodes, e.g. with an identifier that identifies the round of training, which in this case is the previous round of training.

As illustrated by arrow 522 of FIG. 6, the master node 10 selects one or more worker nodes of the plurality of worker nodes 20, 30, 40 to train the machine learning model in a round of training (as described earlier with reference to block 406 of FIG. 3). This round of training will be referred to as a “subsequent” round of training, since it follows the previous round of training. As described earlier, the one or more worker nodes are selected to optimise a performance of an updated machine learning model for a validation dataset after the subsequent round of training. The updated machine learning model has one or more parameters of the machine learning model trained by the one or more worker nodes in a previous round of training.

In more detail, at arrow 522 of FIG. 6, the master node 10 selects the one or more worker nodes by selecting a mask indicative of the one or more worker nodes. The mask can be as described earlier. As illustrated by arrow 524 of FIG. 6, the master node 10 aggregates the one or more parameters of the machine learning model trained by the one or more worker nodes in the previous round of training (as described earlier with reference to block 408 of FIG. 3), which results in the one or more parameters of the updated machine learning model referred to herein. In embodiments involving a mask, the mask may be used in the aggregation.

As described earlier, in some embodiments, the one or more worker nodes may be selected to optimise the performance of the updated machine learning model by selecting the one or more worker nodes that maximise a reward for the performance of the updated machine learning model. Thus, as illustrated by arrow 526 of FIG. 6, the master node 10 may determine a reward for the performance of the updated machine learning model (as described earlier with reference to block 410 of FIG. 3). As mentioned earlier, in some embodiments, the reward for the performance of the updated machine learning model may be based on the performance metric for each of the one or more worker nodes that is indicative of the performance of the worker node. As illustrated by arrow 528 of FIG. 6, the master node 10 may update itself (as described earlier with reference to block 412 of FIG. 3), e.g. store the updated machine learning model in a memory 14 of the master node 10 and/or update a policy used to select the one or more parameters (or the mask) for a given state, such that the overall performance is optimised.

The method may then be repeated. In particular, as illustrated by arrows 530, 532, 534 of FIG. 6, the master node 10 may initiate transmission of the one or more parameters of the machine learning model trained by the one or more worker nodes in the previous round of training towards the one or more worker nodes for the one or more worker nodes to further train the updated machine learning model. As illustrated by arrows 536, 538, 540 of FIG. 6, the one or more worker nodes further train the updated machine learning model. As illustrated by arrows 542, 544, 546 of FIG. 6, the one or more worker nodes 20, 30, 40 may initiate transmission of (e.g. themselves transmit) one or more parameters of the updated machine learning model following the training towards the master node 10. Thus, the master node 10 may receive the one or more parameters of the updated machine learning model following the training.

As also illustrated by arrows 542, 544, 546 of FIG. 6, each of the one or more worker nodes 20, 30, 40 may also initiate transmission of (e.g. themselves transmit) a performance metric that is indicative of a performance of the worker node towards the master node 10. Thus, the master node 10 may also receive a performance metric for each of the one or more worker nodes that is indicative of a performance of the worker node. As illustrated by arrow 548 of FIG. 6, in some embodiments, the master node 10 may store the performance metric for each of the one or more worker nodes, e.g. with an identifier that identifies the round of training, which in this case is the subsequent round of training.

As illustrated by arrow 550 of FIG. 6, the master node 10 selects one or more worker nodes of the plurality of worker nodes 20, 30, 40 to train the updated machine learning model in a subsequent round of training. As before, the one or more worker nodes are selected to optimise a performance of the updated machine learning model for a validation dataset after this subsequent round of training. The validation dataset may be the same validation dataset of a different validation dataset to that used earlier. The updated machine learning model has one or more parameters of the updated machine learning model trained by the one or more worker nodes in the previous round of training.

In more detail, at arrow 550 of FIG. 6, the master node 10 selects the one or more worker nodes by selecting a mask indicative of the one or more worker nodes. The mask can be as described earlier. As illustrated by arrow 552 of FIG. 6, the master node 10 aggregates the one or more parameters of the updated machine learning model trained by the one or more worker nodes in the previous round of training. In embodiments involving a mask, the mask may be used in the aggregation.

As described earlier, in some embodiments, the one or more worker nodes may be selected to optimise the performance of the updated machine learning model by selecting the one or more worker nodes that maximise a reward for the performance of the updated machine learning model. Thus, as illustrated by arrow 554 of FIG. 6, the master node 10 may determine a reward for the performance of the updated machine learning model. As mentioned earlier, in some embodiments, the reward for the performance of the updated machine learning model may be based on the performance metric for each of the one or more worker nodes that is indicative of the performance of the worker node. As illustrated by arrow 556 of FIG. 6, the master node 10 may again update itself.

The method may then be repeated again. In particular, as illustrated by arrows 558, 560, 562 of FIG. 6, the master node 10 may initiate transmission of the one or more parameters of the updated machine learning model trained by the one or more worker nodes in the previous round of training towards the one or more worker nodes for the one or more worker nodes to further train the updated machine learning model and so on. In some embodiments, as illustrated by arrow 564 of FIG. 6, the method may be repeated until a point of convergence is reached, e.g. when a predefined minimum number of training rounds is completed and/or an increase in the performance of the updated machine learning model for the validation dataset is less than a predefined threshold. The method then terminates.

Thus, in the manner described with reference to FIG. 6, the worker nodes can be dynamically explored and certain worker node(s) can be selected for each round of training. This means that the worker nodes that are involved in the different rounds of training may not necessarily be the same. The method described with reference to FIG. 6 can be used to find the best worker node, or the best combination of worker nodes, irrespective of the state of the plurality of worker nodes 20, 30, 40. In the embodiment illustrated in FIG. 6, the state of the master node 10 does not change. The state of the master node 10 is not used as an input to the decision making and thus the actions taken by the master node 10 are not conditioned on the current state of the master node 10. On the other hand, the state of the machine learning model changes as a result of the actions that are taken by the master node 10 and this can affect the decision making (e.g. by affecting the rewards).

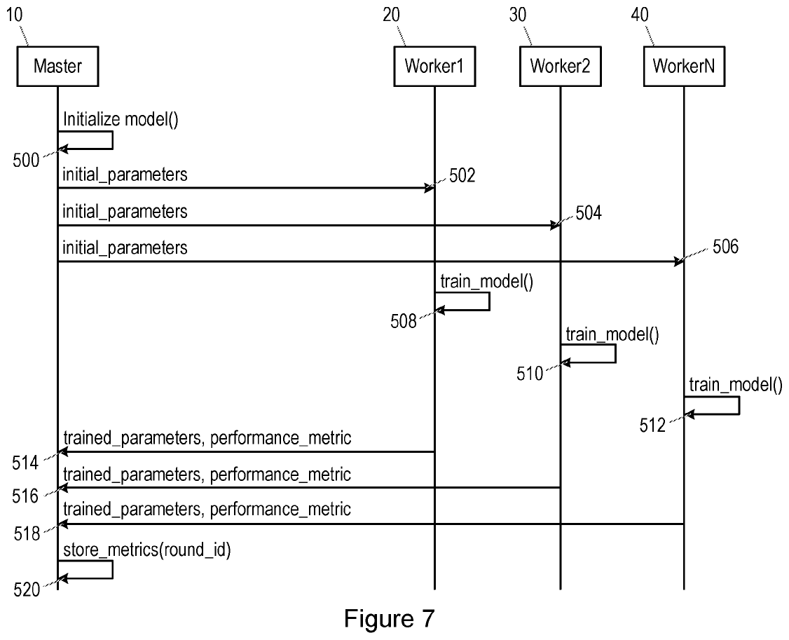

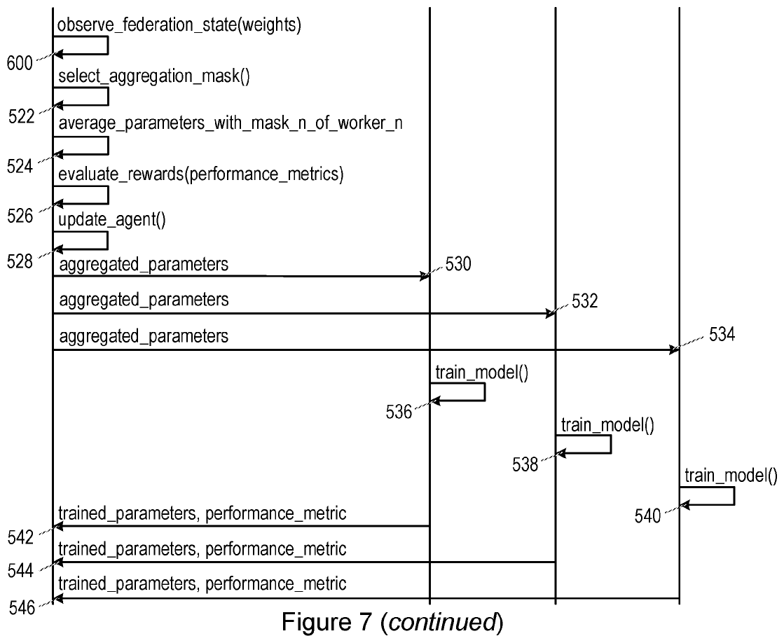

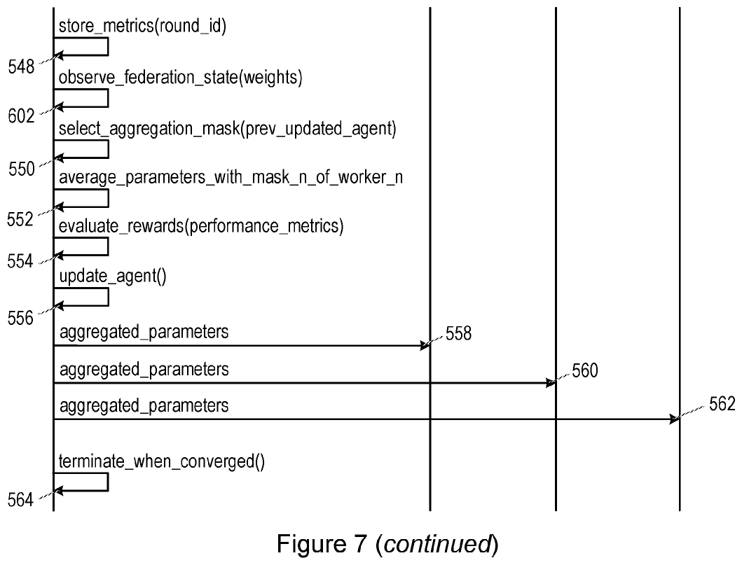

In the embodiment illustrated in FIG. 6, it may be assumed that there is a particular worker node, or a particular combination of worker nodes, that is best at all times, irrespective of the state of the plurality of worker nodes 20, 30, 40. This means that the method may assume that the state of the plurality of worker nodes 20, 30, 40 does not change regardless of the action taken by the master node 10. However, in other embodiments, the state of the plurality of worker nodes 20, 30, 40 may be taken into account and an example of such an embodiment will now be described with reference to FIG. 7.

FIG. 7 is a signalling diagram illustrating an exchange of signals in such a system according to another embodiment. The system illustrated in FIG. 7 comprises the master node 10 described earlier and the plurality of worker nodes 20, 30, 40. The method described earlier with reference to arrows 500 to 564 of FIG. 6 are performed and thus the description of these steps in FIG. 6 will be understood to also apply to the embodiment illustrated in FIG. 7. However, in the embodiment illustrated in FIG. 7, some additional steps are performed.

In particular, as illustrated by arrow 600 of FIG. 7, the master node 10 may check the state of the one or more worker nodes. Thus, the master node 10 may select a weighting for the one or more worker nodes based on a state of the one or more worker nodes. The weighting can be selected to optimise the performance of the updated machine learning model for the validation dataset after the subsequent round of training 536, 538, 540. The weighting can control the amount by which each of the one or more worker nodes contributes to training the machine learning model in that subsequent round of training. In embodiments involving a mask, the mask can be indicative of the one or more worker and the weighting for the one or more worker nodes.

Similarly, as illustrated by arrow 602 of FIG. 7, the master node 10 may check the state of the one or more worker nodes after the subsequent round of training 536, 538, 540. Thus, the master node 10 may select a weighting for the one or more worker nodes based on that state of the one or more worker nodes. As before, the weighting can be selected to optimise the performance of the updated machine learning model for the validation dataset after the (next) subsequent round of training 558, 560, 562. The weighting can control the amount by which each of the one or more worker nodes contributes to training the machine learning model in that subsequent round of training. In embodiments involving a mask, the mask can be indicative of the one or more worker and the weighting for the one or more worker nodes.

Thus, according to the embodiment illustrated in FIG. 7, the state of the plurality of worker nodes 20, 30, 40 may be taken into account. In this way, if the optimal worker nodes or combination of worker nodes can change based on the state of the worker node(s) that are involved in the training, then this will be identified.

The decisions of the master node 10 described herein can be based directly on an observation of the machine learning model. In some embodiments, the master node 10 may learn a policy to select the one or more parameters (or the mask) for a given state, such that the overall performance is optimised. The policy can be learned based on the observed effects of the actions chosen. For example, in some embodiments, the master node 10 may learn a function that maps an observation of the state of the federation to the one or more selected worker nodes (or to the mask according to some embodiments) and that tells the master node 10 how much of the machine learning model trained by each of the one or more selected worker nodes is to contribute to the next round of training. The learning of a policy can comprise approximating an action-value function, directly training a policy function, or approximating an action-value function and deriving a policy function from that. The learning of the policy can be performed online (e.g. as in the embodiment illustrated in FIG. 6) or by pre-training the master node 10.

In the manner described herein, a reinforcement learning based method can be used to dynamically (and, for example, in an automated manner) select one or more worker nodes that will eventually benefit the accuracy of the machine learning model. In some embodiments, the one or more nodes can be selected for a specific worker node, such that the one or more selected worker nodes will eventually benefit the accuracy of the machine learning model for that specific worker node. Also, this can be achieved for any number of specific worker nodes and even for all worker nodes (e.g. in parallel and/or simultaneously). The accuracy of the machine learning model trained by a worker node can be improved through the selection of one or more worker nodes according to the method described herein, while the training time can also be reduced.

Moreover, the method described herein maintains the privacy of local datasets of the worker nodes as it avoids the transfer of these raw datasets over the communication channel between the master node and the worker nodes. The method described herein also avoids the need for non-trivial manual work that is required in the existing techniques that operate by grouping together similar worker nodes (either according to their local datasets or their local machine learning model parameters). Instead, the method described herein achieves the same, if not better, grouping of worker nodes in a simple and effective manner without the need for manual input. The method described herein can also assist in the prevention of poisonous attacks.

The method described herein can be used with any number of worker nodes but can be particularly advantageous when used on small number of worker nodes, e.g. for silo-based federated learning. A small number of worker nodes may, for example, be 2ⁿ network nodes where n<5, rather than thousands or millions of worker nodes. The limited size of the environment provides the flexibility of exploring the whole environment, if desired. However, according to the method described herein, this is not necessary.

There exist numerous use cases for the method described herein and these use cases include those in the domain of telecommunication networks. These telecommunication networks can consist of distributed network elements across various locations, e.g. locations spread around the world. There also exists natural hierarchical topology in telecommunication networks, such as multiple cells connected to a site and a group of sites connected to each other via other sites. Similarly, there are geographical regions that may each comprise local data centers. In this way, local nodes within the proximity of a local data center can send observations (e.g. collected data samples) to the local data center. A machine learning model can be trained on these local data centers for a validation dataset representing a plurality of local sites and cells. Thus, the method described herein can be applied to this use case.

In some embodiments, the machine learning model referred to herein may be trained to predict one or more events in a telecommunications network. More specifically, according to some embodiments, the master node 10 (or the processing circuitry 12 of the master node 10) described herein can be configured to train the machine learning model to predict one or more events in a telecommunications network. In some embodiments, the trained machine learning model may be applied to predict the one or more events in the telecommunications network. More specifically, the master node 10 (or the processing circuitry 12 of the master node 10) described herein can be configured to apply the trained machine learning model to predict one or more events in the telecommunications network according to some embodiments. The one or more events in the telecommunications network can, for example, comprise degradation in a key performance indicator (KPI) of the telecommunications network, a (e.g. hardware and/or software) fault in the telecommunications network, and/or any other event in the telecommunications network.

There is also provided a computer program comprising instructions which, when executed by processing circuitry (such as the processing circuitry 12 of the master node 10 described earlier), cause the processing circuitry to perform at least part of the method described herein. There is provided a computer program product, embodied on a non-transitory machine-readable medium, comprising instructions which are executable by processing circuitry (such as the processing circuitry 12 of the master node 10 described earlier) to cause the processing circuitry to perform at least part of the method described herein. There is provided a computer program product comprising a carrier containing instructions for causing processing circuitry (such as the processing circuitry 12 of the master node 10 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the master node functionality described herein can be performed by hardware. Thus, in some embodiments, the master node 10 described herein can be a hardware node. However, it will also be understood that optionally at least part or all of the master node functionality described herein can be virtualized. For example, the functions performed by the master node 10 described herein can be implemented in software running on generic hardware that is configured to orchestrate the master node functionality. Thus, in some embodiments, the master node 10 described herein can be a virtual node. In some embodiments, at least part or all of the master node functionality described herein may be performed in a network enabled cloud. Thus, the method described herein can be realised as a cloud implementation according to some embodiments. The master node functionality described herein may all be at the same location or at least some of the master node functionality may be distributed, e.g. the master node functionality may be performed by one or more different entities.

It will be understood that at least some or all of the method steps described herein can be automated in some embodiments. That is, in some embodiments, at least some or all of the method steps described herein can be performed automatically. In some embodiments, the method described herein can be performed in real-time. For example, when a worker node (or federation) is being trained, the master node 10 can influence the training as it happens. The method described herein can be a computer-implemented method.

Therefore, in the manner described herein, there is advantageously provided an improved technique for managing training of a machine learning model. The technique described herein can be used to perform adaptive optimisation using reinforcement learning techniques in a federated learning setting.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method performed by a master node for managing training of a machine learning model, the method comprising:
selecting one or more worker nodes of a plurality of worker nodes to train a machine learning model in a round of training,
wherein the one or more worker nodes are selected to optimize a performance of an updated machine learning model for a validation dataset after the round of training, wherein the updated machine learning model has one or more parameters of the machine learning model trained by the one or more worker nodes in a previous round of training.

2. The method as claimed in claim 1, wherein:
selecting the one or more worker nodes comprises:
selecting a mask indicative of the one or more worker nodes.

3. The method as claimed in claim 2, wherein:
the mask is a binary vector comprising a value of one to indicate the one or more worker nodes and a value of zero to indicate any other worker nodes of the plurality of worker nodes.

4. The method as claimed in claim 1, wherein:
the one or more worker nodes are selected to optimize the performance of the updated machine learning model by selecting the one or more worker nodes that maximize a reward for the performance of the updated machine learning model.

5. The method as claimed in claim 4, wherein:
the reward for the performance of the updated machine learning model is maximized if it is determined to be higher than a reward for a performance of the machine learning model in a previous round of training.

6. The method as claimed in claim 4, wherein:
the reward for the performance of the updated machine learning model is based on a performance metric for each of the one or more worker nodes that is indicative of a performance of the worker node.

7. The method as claimed in claim 6, the method comprising:
receiving the performance metric from each of the one or more worker nodes.

8. The method as claimed in claim 1, wherein:
the one or more parameters of the updated machine learning model comprise an aggregation of the one or more parameters of the machine learning model trained by the one or more worker nodes in the previous round of training.

9. The method as claimed in claim 8, the method comprising:
aggregating the one or more parameters of the machine learning model trained by the one or more worker nodes in the previous round of training.

10. The method as claimed in claim 8, wherein:
the aggregation is an average.

11. The method as claimed in claim 1, wherein:
the selection is performed for at least one worker node of the plurality of worker nodes; and
for each worker node for which the selection is performed, the one or more worker nodes are selected to optimize the performance of the updated machine learning model for that worker node.

12. The method as claimed in claim 11, wherein:
the selection is performed for at least two worker nodes of the plurality of worker nodes simultaneously.

13. The method as claimed in claim 11, wherein:
for each worker node for which the selection is performed, the validation dataset is a validation dataset of that worker node.

14. The method as claimed in claim 1, the method comprising:
initiating transmission of the one or more parameters of the machine learning model trained by the one or more worker nodes in the previous round of training towards the one or more worker nodes for the one or more worker nodes to further train the updated machine learning model.

15. The method as claimed in claim 1, the method comprising:
repeating the method until a point of convergence is reached.

16. The method as claimed in claim 15, wherein:
the point of converge is reached when:
a predefined minimum number of training rounds is completed; and/or
an increase in the performance of the updated machine learning model for the validation dataset is less than a predefined threshold.

17. The method as claimed in claim 1, the method comprising:
prior to selecting the one or more worker nodes:
initiating transmission of one or more parameters of the machine learning model towards the one or more worker nodes for the one or more worker nodes to train the machine learning model in the previous round of training; and
receiving the one or more parameters of the machine learning model trained by the one or more worker nodes in the previous round of training from the one or more worker nodes.

18. The method as claimed in claim 1, the method comprising:
selecting a weighting for the one or more worker nodes that controls the amount by which each of the one or more worker nodes contributes to training the machine learning model in the round of training,
wherein the weighting is selected to optimize the performance of the updated machine learning model for the validation dataset after the round of training.

19. The method as claimed in claim 18, wherein:
the weighting is selected based on a state of the one or more worker nodes.

20-32. (canceled)

33. A master node for managing training of a machine learning model, the master node comprising processing circuitry configured to cause the master node to:
select one or more worker nodes of a plurality of worker nodes to train a machine learning model in a round of training,
wherein the one or more worker nodes are selected to optimize a performance of an updated machine learning model for a validation dataset after the round of training, wherein the updated machine learning model has one or more parameters of the machine learning model trained by the one or more worker nodes in a previous round of training.
